(19) United States
(12) Patent Application Publication
(10) Pub. No.: US 2006/0095150 A1
(43) Pub. Date: May 4, 2006

(54) Installation control method, installation control apparatus and installation control program

(75) Inventor: Takafumi Inoue, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/208,324

(22) Filed: Aug. 19, 2005

(30) Foreign Application Priority Data
Aug. 31, 2004 (JP) 2004-251258

(51) Int. Cl. G06F 19/00

(52) U.S. Cl. 700/95

(57) ABSTRACT

The operation history of operations accepted by a terminal is stored in a storage device. The history of events having occurred in an installation is also stored in the storage device. A process server extracts the time series regularity of the operations and the events with reference to the stored operation history and event history, and executes a process reflecting the extracted regularity. The process predicts the next operation on the basis of the extracted regularity so as to facilitate the acceptance of the particular operation may well be executed. Besides, the next operation may well be predicted on the basis of the extracted regularity so as to execute the operating content thereof.

### CROSS-REFERENCE TO RELATED APPLICATIONS

This application is based upon and claims the benefit of priority from the prior Japanese Patent Applications No. 2004-251258, filed on Aug. 31, 2004, the entire contents of which are incorporated herein by reference.

### BACKGROUND OF THE INVENTION

1. Field of the Invention

The present invention relates to an installation control method of controlling an installation such as a plant on the basis of accepted operations, and an installation control apparatus and an installation control program. More particularly, it relates to an installation control method capable of executing an appropriate process on the basis of the regularity of operations, and an installation control apparatus and an installation control program.

2. Description of the Related Art

There has been known a control system wherein a plant can be extensively monitored by terminals. In such a control system, the plant is usually controlled by automatic running. Besides, in such a case where an alarm notifying any abnormality has occurred, part of the system is switched-over to manual running, whereby the control of the plant can be performed by a manual operation for the terminal.

FIG. 7 shows an example of an operating procedure for releasing an alarm in the case of the occurrence of the alarm. An operator who has recognized the occurrence of the alarm, causes the terminal to display on the monitor (not shown) thereof the tuning panel of an instrument or a device which has formed the cause of the alarm. Subsequently, the operator switches-over the instrument or device from the automatic running to the manual running, and he/she causes the terminal to display on the monitor thereof a trend screen for displaying a current situation (a screen which visually shows the time variations of the detection values of sensors, etc.) By way of example, the temporal variation of a flow rate measured by the instrument, and the value of a temperature are shown on the trend screen. In the example of FIG. 7, the operator changes-over a set value for controlling a process, in order to release the alarm. Here, it is exemplified to change-over the set value from “0” to “50”. After such an operation, the operator restores the running mode from the manual running to the automatic running and ends the process.

JP-A-9-196714 discloses an operation-history management device wherein information items which are relevant to various jobs performed by an operator and events having occurred on a control apparatus side are saved together with time information.

JP-A-9-196714 is referred to as a related art.

In a case where an identical alarm is repeated, ordinarily an operating procedure for coping with the alarm becomes the same. It is therefore considered that, when a similar situation has occurred, a process for executing the next operating content or for guiding an operator to the operation should be automated. In the related-art control system, however, the discovery of the regularity of the operating procedure is entrusted to the operator. This poses the problem that the discovery is difficult, so plant operations cannot be efficiently automated. Especially in a case where a long time is required since the alarm till the end of the series of operations, or where another alarm or operation intervenes in the series of operations, it is very difficult to find out the regularity. Besides, since the operator's sense is resorted to, an omission or a mistake exists in the regularity. Further, granted that the history of the alarms or operations can be recorded and referred to, operations etc. irrelevant to the series of alarms or operations intervene in large quantities, and hence, it is next to impossible to extract information necessary for the automation.

### SUMMARY OF THE INVENTION

An object of the invention is to provide an installation control method and an installation control apparatus which can execute an appropriate process on the basis of the regularity of operations etc., and an installation control program which causes a computer to execute the installation control method.

The invention provides an installation control method of controlling an installation based on accepted operations, having the steps of: storing an operation history of the accepted operations; and extracting a time series regularity of the accepted operations with reference to the operation history.

According to the installation control method, since the time series regularity of the operations is extracted with reference to the operation history, the automation of the control and the enhancement of an operability can be attained by extracting the useful regularity.

The invention also provides an installation control method of controlling an installation based on accepted operations, having the steps of: storing an operation history of the accepted operations; storing an event history of events which occur in the installation; and extracting a time series regularity of the accepted operations and the occurred events with reference to the operation history and the event history.

According to the installation control method, since the time series regularity of the operations is extracted with reference to the operation history and the event history, the automation of the control and the enhancement of an operability can be attained by extracting the useful regularity.

The installation control method may have the step of executing a process which reflects the extracted regularity. The process may indicate the extracted regularity.

In the installation control method, the step of executing the process may include the steps of: predicting a next operation based on the extracted regularity; and executing a process for facilitating acceptance of the next operation. In this case, an operability can be enhanced.

In the installation control method, the step of executing the process may include the steps of: predicting a next operation based on the extracted regularity; and executing a process based on the next operation.

In this case, the automation of the control can be attained.

The invention also provides an installation control apparatus for controlling an installation based on accepted operations, having: an operation-history storage section which stores an operation history of the accepted operations; and a regularity extraction section which extracts a time series regularity of the accepted operations with reference to the operation history.

According to the installation control apparatus, since the time series regularity of the operations is extracted with reference to the operation history, so that the automation of the control and the enhancement of an operability can be attained by extracting the useful regularity.

The invention also provides an installation control apparatus for controlling an installation based on accepted operations, having: an operation-history storage section which stores an operation history of the accepted operations; an event-history storage section which stores an event history of events having that occur in the installation; and a regularity extraction section which extracts a time series regularity of the accepted operations and the occurred events with reference to the operation history and the event history.

According to the installation control apparatus, since the time series regularity of the operations is extracted with reference to the operation history and the event history, the automation of the control and the enhancement of an operability can be attained by extracting the useful regularity.

The installation control apparatus may have a process execution section which executing a process that reflects the extracted regularity. The process execution section may indicate the extracted regularity.

In the installation control apparatus, the process execution section predicts a next operation based on the extracted regularity, and executes a process for facilitating acceptance of the next operation.

In this case, an operability can be enhanced.

In the installation control apparatus, the process execution section predicts a next operation based on the extracted regularity, and executes a process based on the next operation.

In this case, the automation of the control can be attained.

The invention also provides an installation control program for implementing an installation control method of controlling an installation based on accepted operations, causing a computer to execute the steps of: storing an operation history of the accepted operations; and extracting a time series regularity of the accepted operations with reference to the operation history.

According to the installation control program, since the time series regularity of the operations is extracted with reference to the operation history, the automation of the control and the enhancement of an operability can be attained by extracting the useful regularity.

The invention also provides an installation control program for implementing an installation control method of controlling an installation based on accepted operations, causing a computer to execute the steps of:

storing an operation history of the accepted operations; storing an event history of events which occur in the installation; and extracting a time series regularity of the accepted operations, and the occurred events with reference to the operation history and the event history.

According to the installation control program, since the time series regularity of the operations is extracted with reference to the operation history and the event history, the automation of the control and the enhancement of an operability can be attained by extracting the useful regularity.

The computer may well be caused to execute the step of executing a process which reflects the extracted regularity.

The process may indicate the extracted regularity.

In the installation control program, the step of executing the process may include the steps of: predicting a next operation based on the extracted regularity; and executing a process for facilitating acceptance of the next operation.

In this case, an operability can be enhanced.

In the installation control program, the step of executing the process may include the step of: predicting a next operation based on the extracted regularity; and executing a process based on the next operation.

In this case, the automation of the control can be attained.

According to the installation control method, the installation control apparatus and the installation control program, since the time series regularity of operations is extracted on the basis of history data, an appropriate process can be executed. As a result, automation and enhancement in operability, etc. can be attained.

### BRIEF DESCRIPTION OF THE DRAWINGS

FIG. 1 is a block diagram showing the configuration of a control system to which the installation control method of the present invention is applied;

FIG. 2 is a diagram showing the data configuration of data which are stored in a storage device;

FIG. 3 is a block diagram showing the functions of a process server;

FIG. 4 is a flow chart showing the procedure of a process for storing an operation history and the history of events;

FIG. 5 is a flow chart showing the procedure of a process for extracting the time series regularity of operations and events;

FIG. 6 is a flow chart showing a procedure for executing a process based on the extracted regularity; and

FIG. 7 is a diagram showing an example of an operating procedure for releasing an alarm.

### DETAILED DESCRIPTION OF THE PREFERRED EMBODIMENTS

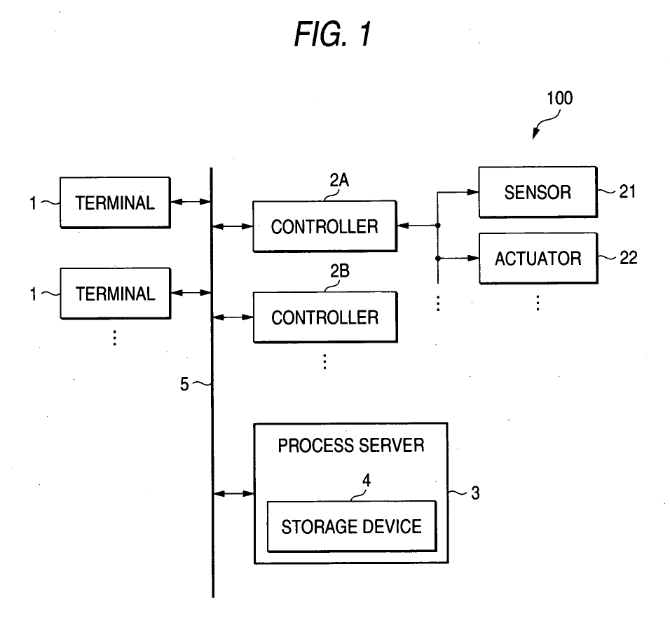

An embodiment of an installation control method according to the present invention will be described with reference to FIGS. 1 to 6. This embodiment shows an example in which the invention is applied to a control system for controlling a plant.

FIG. 1 is a block diagram showing the configuration of the control system to which the installation control method of the invention is applied. As shown in FIG. 1, the control system 100 includes terminals 1 which accept the operations of an operator, controllers 2A, 2B which control the individual parts of the plant, and a process server 3 which generally controls the control system 100. The terminals 1, the controllers 2A, 2B, and the process server 3 are interconnected by a communication line 5.

As shown in FIG. 1, instruments such as sensors 21 for monitoring the individual parts of the plant, driver groups such as actuators 22 disposed in the various devices of the plant, and so forth, are connected to the controller 2A. The same holds true also of the other controllers.

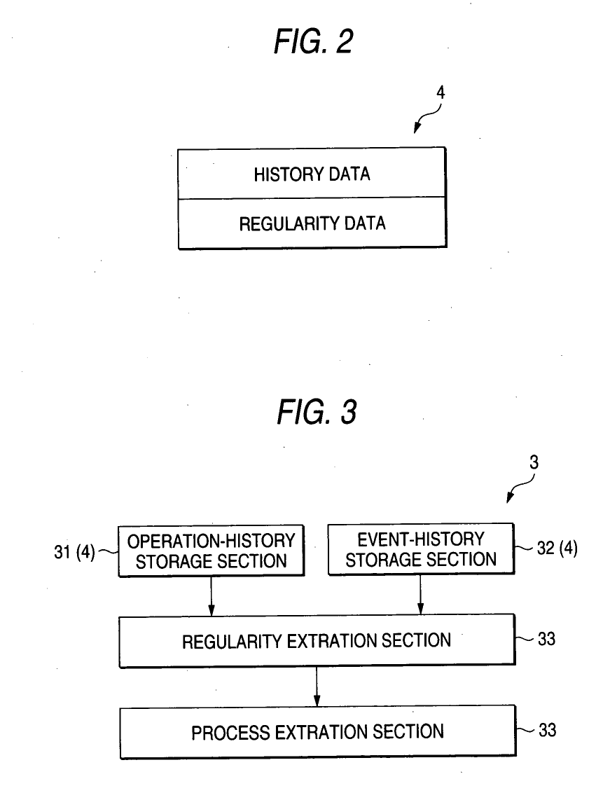

As shown in FIG. 1, a storage device 4 is disposed in the process server 3. As shown in FIG. 2, history data and regularity data are stored in the storage device 4. The history data and the regularity data will be further explained later.

FIG. 3 is a block diagram showing the functions of the process server 3, according to the invention. The process server 3 constructs operation-history storage section 31 for storing the operation history of accepted operations therein, event-history storage section 32 for storing therein the history of events which have occurred in the plant, regularity extraction section 33 for extracting the time series regularity of the operations and the events with reference to the operation history stored in the operation-history storage section 31 and the history of the events as stored in the event-history storage section 32, and process execution section 34 for executing a process which reflects the extracted regularity. The storage unit 4 (FIG. 1) functions as the operation-history storage section 31 and the event-history storage section 32.

Next, the operation of the control system 100 will be described below.

In the control system 100, a running mode is ordinarily set at automatic running, and the plant is automatically controlled without resorting to operations from the terminals 1. In the automatic running mode, the controllers 2A, 2B control the individual parts of the plant on the basis of information items from these plant parts. Besides, the process server 3 generally controls the controllers 2A, 2B, and it offers the terminals 1 information items acquired through the controllers 2A, 2B, for example, information items on various measurement values and events having occurred in the plant.

On the other hand, when the running mode of the control system 100 is switched-over to manual running, the plant control can be partially or wholly executed by manual operations. In this case, the individual parts of the plant are manually controlled in accordance with operations accepted by the terminals 1, within the switched-over range of the manual operations.

Next, the operation of the process server 3 according to the invention will be described.

As shown in FIG. 3, the operation-history storage section 31 stores therein the history of those operations of the operator which have been performed through the terminals 1. Also, the event-history storage section 32 stores therein the history of the events which have occurred in the plant. The regularity extraction section 33 extracts the time series regularity of the operations and the events with reference to the operation history stored in the operation-history storage section 31 and the history of the events as stored in the event-history storage section 32. The process execution section 34 executes a process which reflects the regularity extracted by the regularity extraction section 33.

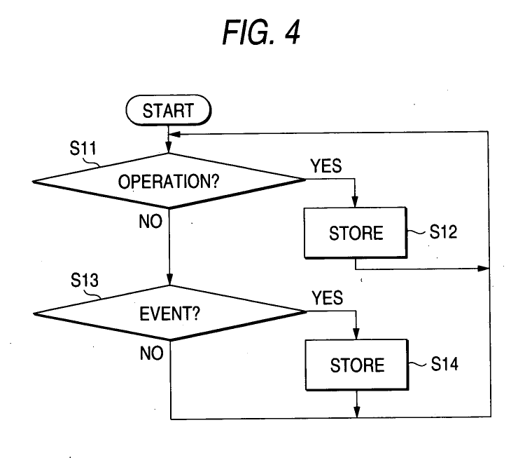

FIG. 4 is a flow chart showing the procedure of a process for storing the operation history and the history of the events. This process corresponds to the functions of the operation-history storage section 31 and the event-history storage section 32, and is executed on the basis of the control of the process server 3 conforming to a program.

First, at a step S11 in FIG. 4, whether or not any operation has been accepted by the terminal 1 is judged. If the judgment is affirmed, the routine proceeds to a step S12, and if the judgment is negated, the routine proceeds to a step S13. At the step S12, the operation accepted by the terminal 1 is stored in the storage device 4, whereupon the process is ended. In this process, the contents of the accepted operation are stored and accumulated as the history data (FIG. 2) together with the operation time thereof. Incidentally, the contents of the operation contain information which specifies the terminal 1 having accepted the operation.

On the other hand, at the step S13, whether or not any event has occurred is judged. If the judgment is affirmed, the routine proceeds to a step S14, and if the judgment is negated, the routine returns to the step S11. At the step S14, the event having occurred is stored in the storage device 4, whereupon the process is ended. In this process, the contents of the event having occurred are stored and accumulated as the history data (FIG. 2) together with the event occurrence time thereof.

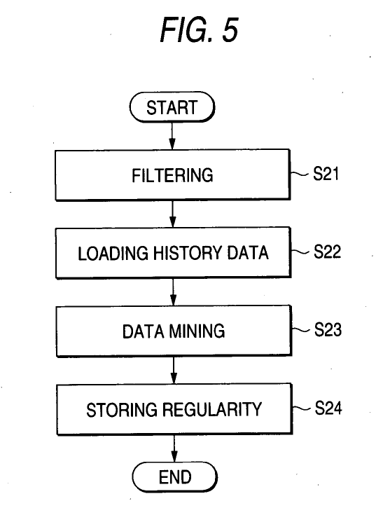

FIG. 5 is a flow chart showing the procedure of a process for extracting the time series regularity of the operations and the events on the basis of the history data stored in the storage device 4. This process corresponds to the function of the regularity extraction section 33, and is executed on the basis of the control of the process server 3 conforming to a program. Besides, this process is executed in compliance with an instruction given through the terminal 1, or it is automatically executed every appropriate timing.

Here, the “operation” is an operation which is performed for the terminal 1. The “event” is a concept which extensively covers any event that occurs in the control system 100 and that is recognizable by the process server 3, and it corresponds to, for example, any alarm which notifies an abnormality.

First, at a step S21 in FIG. 5, the operation of extracting the regularity and the range of the events are designated by filtering. When the range is appropriately designated, subjects for the extraction of the regularity can be refined, and the extraction of any false regularity attributed to an accident or a misoperation can be excluded. Such a range can be refined using, for example, times at which the operations were accepted, times at which the events occurred, a region which is controlled by a specified one of the controllers 2, and a region which is monitored by a specified one of the instruments. Besides, it is not reasonable to correlate the operations performed at two or more different ones of the terminals 1 and to judge a regularity. Therefore, the range can also be refined to only the operations accepted by a specified one of the terminals 1. The designation of the range may comply with the operator's instruction, or may well be automatically done by a predetermined method.

At a step S22, the history data (FIG. 2) within the range designated at the step S21 are loaded from the storage device 4. At a step S23, the loaded history data are subjected to data mining. At a step S24, the time series regularity of the operations and the events as extracted by the data mining is obtained, and this regularity is stored as the regularity data (FIG. 2) in the storage device 4, whereupon the process is ended.

The processing of the steps S23 and S24 will be described below.

A single operation or event, or at least one set consisting of operations or events shall be denoted as an element A, B, C or D. That is, each of the elements A, B, C and D may be either the single operation or the set of the plurality of operations arrayed in a predetermined sequence. Besides, it may be either the single event or the set of the plurality of events arrayed in a predetermined sequence. Further, it may well be a plurality of sets consisting of the operations or events arrayed in a predetermined sequence. In this case, each set may consist of either the single operation and event or the plurality of operations and events.

Here, using the data mining, the series of operations and events in the sequences of, for example, (a) A→B→C→D, (b) A→B→C, and (c) A→B can be extracted from the data history. In this case, owing to the use of the data mining, the series of operations or events can be extracted even when a disturbance, such as an operation for any other terminal 1 or an event having no causal relation to the operation included in each element, exists between the respective elements, for example, in the course of A→B. Regarding such series of operations and events, the expected values of the numbers of times of occurrences (occurrence rates) to 24 hours are found. Then, results as indicated below, for example, can be obtained.

(a) A→B→C→D: 45%

(b) A→B→C: 50%

(c) A→B: 70%

(d) B→C: 70%

In this example, the expected value of the number of times of the occurrences of the series of operations and events within 24 hours is 0.45 time for the sequence “(a) A→B→C→D”, 0.5 time for the sequence “(b) A→B→C”, 0.7 time for the sequence “(c) A→B”, and 0.7 time for the sequence “(d) B→C”. In this manner, the time series regularity of the operations and the events can be extracted on the basis of the occurrence rate of the series of operations and events conforming to the predetermined sequence. By way of example, in a case where the operations in the predetermined sequence occur at a high occurrence rate, it can be assessed that the regularity exists in the particular operation sequence. Besides, the existence or nonexistence of the regularity can be assessed so as to reflect, not only the occurrence rate, but also the contents of the operation sequence. By way of example, as compared with the sequence “(b) A→B→C”, the sequence “(c) A→B” or “(d) B→C” included in this sequence “(b) A→B→C” becomes higher in the occurrence rate. It is sometimes more reasonable, however, that the regularity is judged for the sequence “(b) A→B→C” without judging the regularity for the sequence “(c) A→B” or “(d) B→C”, and that the sequence “(c) A→B” or “(d) B→C” is handled as being included in the regular sequence “(b) A→B→C”.

Besides, in a case where an operation group of certain predetermined sequence is followed by an operation group of predetermined sequence occurring at a high frequency, a regularity is judged between the former operation group and the latter operation group. In, for instance, the above example, the occurrence rate of the sequence “(b) A→B→C” and that of the sequence “(a) A→B→C→D” are close values. Besides, if it is known that the operation “D” occurs at a high probability after the operations “(b) A→B→C”, the occurrence of the next operation “D” can be predicted when the operations “(b) A→B→C” have been done. In this manner, the regularity can be extracted by considering, not only the occurrence rate of the series of operations etc., but also the relation of the series of operations etc. to the preceding or succeeding operation or event.

That time series regularity of the operations and the events which has been extracted by the data mining, can be reflected on a process in the control system 100.

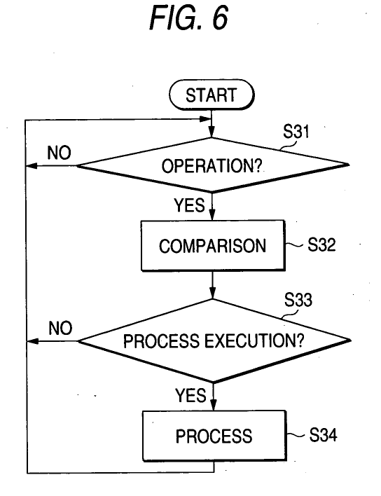

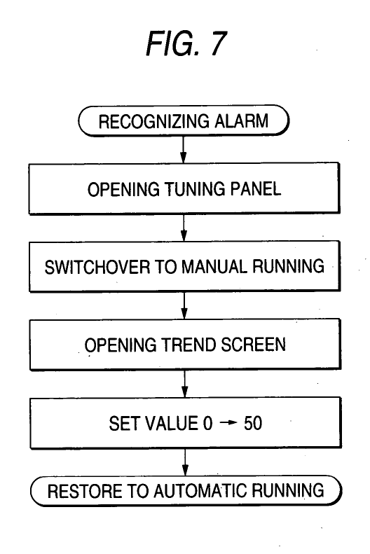

FIG. 6 is a flow chart showing a procedure which executes the process based on the extracted regularity. This process corresponds to the functions of the process execution section 34, and is executed on the basis of the control of the process server 3 conforming to a program.

At a step S31 in FIG. 6, whether or not an operation for the terminal 1 has been performed is judged. The routine proceeds to a step S32 upon the affirmation of the judgment. At the step S32, the regularity data (FIG. 2) stored in the storage device 4 are searched for, and a series of operations currently accepted by the terminal 1 or events occurring in the control system 100 are compared with the series of operations or events included in the regularity data. Subsequently, at a step S33, whether or not the predetermined process is to be executed is judged on the basis of the result of the comparison at the step S32. If the judgment is affirmed, the routine proceeds to a step S34, and if the judgment is negated, the routine returns to the step S31. At the step S34, the predetermined process is executed, whereupon the series of processing steps are ended.

As the process which is performed at the step S34, the next operation succeeding to the currently accepted operations may well be predicted so as to execute the operating content thereof. In a case, for example, where the next operation is predicted to be an operation for altering the set value of any instrument of the plant to a predetermined value, the set value of this instrument is altered to the particular value. Thus, the automation of the operations can be attained.

Also, a process which facilitates the acceptance of the next predicted operation may well be executed. By way of example, a predetermined screen may well be displayed on the monitor of the terminal 1 so that the operator can easily perform the next operation. There is automatically displayed, for example, a tuning panel (a panel for adjusting the set values of the instruments), a trend screen (a screen visually showing the time variations of the detection values of the sensors), or a graphic (a screen visually showing the current situation) as is required for the next operation. Thus, the operations of the operator can be effectively supported, so that rapid operations are permitted, and misoperations are effectively preventable.

Even if such a screen is not displayed, it may well be indicated as a candidate for a subject for the next display. In a case where a plurality of candidates exist as the next predicted operations, a plurality of candidates for screens to be subsequently displayed may well be indicated so that the operator can select any of the screens.

Further, a regular operating procedure or the like may well be indicated so as to entrust a method for utilizing the indicated regularity, to the operator. In this case, by way of example, the operator performs programming while confirming the regularity, whereby the automation etc. of operations can be attained. The indication of the operating procedure may be done at, for example, a timing which complies with the operator's request.

As explained above, in this embodiment, the history data of operations and events are stored, and they are analyzed using data mining, thereby to extract the time series regularity of the operations and the events. Therefore, the operations necessary for automation etc. can be distinguished from misoperations or irrelevant operations for the other terminals 1, so as to effectively extract only the useful regularity. Besides, according to this embodiment, a regularity of which an operator is not aware can be indicated, or a process which utilizes such a regularity can be executed. Especially, even in a case where a long time is expended on the series of operations or events, or where another operation or event intervenes midway of the series of operations or events, the regularity can be extracted. Therefore, the automation etc. of plant operations can be efficiently promoted. Further, since a regularity can be extracted also for the occurrence situation of events, it is possible to efficiently detect, for example, a situation where a plurality of “trail” alarms occur in chain-like fashion. It is accordingly possible to attain the automation of plant operations, enhancement in operability, or lowering in the occurrence rate of alarms.

The applicable scope of the invention is not restricted to the foregoing embodiment. The invention is extensively applicable, not only to the control system for the plant, but also to other control systems which perform controls for various installations.

What is claimed is:

1. An installation control method of controlling an installation based on accepted operations, comprising the steps of:
storing an operation history of the accepted operations; and
extracting a time series regularity of the accepted operations with reference to the operation history.

2. An installation control method of controlling an installation based on accepted operations, comprising the steps of:
storing an operation history of the accepted operations;
storing an event history of events which occur in the installation; and
extracting a time series regularity of the accepted operations and the occurred events with reference to the operation history and the event history.

3. The installation control method according to claim 1, further comprising the step of:
executing a process which reflects the extracted regularity.

4. The installation control method according to claim 2, further comprising the step of:
executing a process which reflects the extracted regularity.

5. The installation control method according to claim 3,
wherein the step of executing the process includes the steps of:
predicting a next operation based on the extracted regularity; and
executing a process for facilitating acceptance of the next operation.

6. The installation control method according to claim 4,
wherein the step of executing the process includes the steps of:
predicting a next operation based on the extracted regularity; and
executing a process for facilitating acceptance of the next operation.

7. The installation control method according to claim 3,
wherein the step of executing the process includes the steps of:
predicting a next operation based on the extracted regularity; and
executing a process based on the next operation.

8. The installation control method according to claim 4,
wherein the step of executing the process includes the steps of:
predicting a next operation based on the extracted regularity; and
executing a process based on the next operation.

9. An installation control apparatus for controlling an installation based on accepted operations, comprising:
an operation-history storage section which stores an operation history of the accepted operations; and
a regularity extraction section which extracts a time series regularity of the accepted operations with reference to the operation history.

10. An installation control apparatus for controlling an installation based on accepted operations, comprising:
an operation-history storage section which stores an operation history of the accepted operations;
an event-history storage section which stores an event history of events having that occur in the installation; and
a regularity extraction section which extracts a time series regularity of the accepted operations and the occurred events with reference to the operation history and the event history.

11. The installation control apparatus according to claim 9, further comprising:
a process execution section which executing a process that reflects the extracted regularity.

12. The installation control apparatus according to claim 10, further comprising:
a process execution section which executing a process that reflects the extracted regularity.

13. The installation control apparatus according to claim 11,
wherein the process execution section predicts a next operation based on the extracted regularity, and executes a process for facilitating acceptance of the next operation.

14. The installation control apparatus according to claim 12,
wherein the process execution section predicts a next operation based on the extracted regularity, and executes a process for facilitating acceptance of the next operation.

15. The installation control apparatus according to claim 11,
wherein the process execution section predicts a next operation based on the extracted regularity, and executes a process based on the next operation.

16. The installation control apparatus according to claim 12,
wherein the process execution section predicts a next operation based on the extracted regularity, and executes a process based on the next operation.

17. An installation control program for implementing an installation control method of controlling an installation based on accepted operations, causing a computer to execute the steps of:
storing an operation history of the accepted operations; and
extracting a time series regularity of the accepted operations with reference to the operation history.

18. An installation control program for implementing an installation control method of controlling an installation based on accepted operations, causing a computer to execute the steps of:
storing an operation history of the accepted operations;
storing an event history of events which occur in the installation; and
extracting a time series regularity of the accepted operations and the occurred events with reference to the operation history and the event history.

19. The installation control program according to claim 17,
wherein the computer is caused to execute the step of executing a process which reflects the extracted regularity.

20. The installation control program according to claim 18,
wherein the computer is caused to execute the step of executing a process which reflects the extracted regularity.

21. The installation control program according to claim 19,
wherein the step of executing the process includes the steps of:
predicting a next operation based on the extracted regularity; and
executing a process for facilitating acceptance of the next operation.

22. The installation control program according to claim 20,
wherein the step of executing the process includes the steps of:
predicting a next operation based on the extracted regularity; and
executing a process for facilitating acceptance of the next operation.

23. The installation control program according to claim 19,
wherein the step of executing the process includes the step of:
predicting a next operation based on the extracted regularity; and
executing a process based on the next operation.

24. The installation control program according to claim 20,
wherein the step of executing the process includes the step of:
predicting a next operation based on the extracted regularity; and
executing a process based on the next operation.
